(19) United States
(12) Patent Application Publication
(10) Pub. No.: US 2026/0062246 A1
(43) Pub. Date: Mar. 5, 2026

(54) COMPACT END EFFECTOR FOR THE APPLICATION OF DOUBLE-SIDED ADHESIVE TAPES WITH AN INTEGRATED ROLL

(71) Applicant: TESA SE, Norderstedt (DE)

(72) Inventors: Tristan WIENZEK, Norderstedt (DE); Hans-Peter BRANDT, Norderstedt (DE)

(73) Assignee: TESA SE, Norderstedt (DE)

(21) Appl. No.: 19/107,174

(22) PCT Filed: Aug. 30, 2023
(86) PCT No.: PCT/EP2023/073827

§ 371 Date: Feb. 27, 2025

(30) Foreign Application Priority Data
Aug. 30, 2022 (DE) 10 2022 121 935.6

(51) Int. Cl. B65H 35/00; B25J 15/00; B65H 16/00; B65H 23/182; B65H 41/00; B65H 43/04

(52) U.S. Cl. CPC B65H 35/0013; B25J 15/0019; B65H 16/005; B65H 23/1825; B65H 41/00; B65H 43/04; B65H 2406/30; B65H 2701/3772

(57) ABSTRACT

An end effector configured for the application of double-sided adhesive tapes and comprising: a roll mount; a guide arrangement; an application arrangement; and a removal arrangement. The the roll mount is designed to receive a roll of adhesive tape, the guide arrangement is designed for guiding an adhesive tape provided by a roll of adhesive tape arranged in the roll mount from the roll mount to the application arrangement, and the application arrangement is designed for guiding an adhesive tape fed to the application arrangement in such a manner that, in an application region, the adhesive layer of the adhesive tape lies on the outer side of the end effector, as a result of which the end effector can bring a substrate which is to be adhesively bonded into contact with the adhesive layer of the adhesive tape.

The invention relates to an end effector for the application of double-sided adhesive tapes with an automated movement unit, to an application system, building thereon, for the application of double-sided adhesive tapes, and to a method for the application of double-sided adhesive tapes with a corresponding end effector or application system. Also disclosed is the use of a corresponding end effector for the application of double-sided adhesive tapes, and a preferred end effector system.

In many engineering sectors, for example in the automotive industry, there is a need to connect different components to one another, wherein in particular adhesive bonding has proved to be particularly effective in industry when joining components. So-called adhesive tapes here represent an alternative to the use of amorphous adhesives which are applied, for example, from a tube. In particular, pressure-sensitive adhesive tapes in which a pressure-sensitive adhesive substance which is permanently tacky and adhesive in normal environmental conditions ensures the bonding action are known from everyday life. Corresponding pressure-sensitive adhesive tapes can be applied by being pressed onto a substrate and remain stuck there.

Double-sided adhesive tapes, i.e. adhesive tapes that have an adhesive layer on both sides, are very important in particular for use in industrial manufacturing technology. These double-sided adhesive tapes can namely, for example, allow a wide range of components to be adhesively bonded quickly and with almost no gaps such that they can potentially replace adhesive bonding technologies which exist in modern manufacturing lines in many cases and require, for example, long curing times.

An example of the possible potential for optimization by using double-sided adhesive tapes that can be mentioned is, for example, the fitting of parts to roof linings of vehicles, where there is a need for automated solutions to adhesively bond cables and moulded parts. Liquid hot-melt adhesives are today used in the majority of cases for adhesively bonding moulded parts to the roof lining, whereas cable harnesses are often fixed with a one-sided adhesive tape. Such adhesive bonding of cables and moulded parts with two different adhesive bonding technologies or even just adhesive bonding with a liquid hot-melt adhesive which takes a long time to cure entails more complicated requirements for the automation process. In contrast, a double-sided adhesive tape can be used for both applications and thus potentially afford significant potential for process savings for the automation.

In the opinion of the inventors, to date double-sided adhesive tapes have not been used for both applications for fitting parts to roof linings with the same automation solution. In the opinion of the inventors, this is especially because there is a lack of effective and readily automatable application devices for double-sided adhesive tapes which are used as so-called end effectors on industrial robots or similar movement units. There is accordingly a fundamental need for automated adhesive tape application devices, in particular for the combined use case when adhesively bonding a wide range of components, for example when fitting parts to roof linings.

End effectors for the application of adhesive tapes are known from the prior art which allow the application of adhesive tapes but which are fed via adhesive tape rolls arranged on external unwinding devices. The use of such adhesive tape rolls here allows the application of large amounts of adhesive tape, for example a thousand meters of adhesive tape or more, without there being any need to replace the adhesive tape roll and thus to interrupt production.

In many cases, however, these known end effectors are also found to be disadvantageous, in particular with regard to the required structural space and the relatively limited flexibility. In the case of the corresponding end effectors with a separate roll unwinder, the distance between the external unwinding device and the end effector is namely often relatively long, corresponding to the size of typical manufacturing halls.

In the case of robot movements in the direction of the roll unwinder which is usually arranged laterally offset, as occur for example to reset the adhesive tape, the feed distance is shortened. The already dispensed adhesive tape must for this purpose be retracted again by the roll rewinder in order to ensure the necessary web tension. In many cases, there is therefore also a need to provide a complex feed arrangement which can ensure, for example, a minimum tension in the adhesive tape, for example via a so-called compensator, in order to avoid sagging or undesired sticking of the adhesive tape, in particular in the case of powerful movements of the end effector.

The risk furthermore exists in principle in the case of long feed distances of the adhesive tape getting dirty and thus the bonding quality potentially being reduced. In addition, a corresponding feed arrangement from an external roll unwinder in an automated manufacturing line can constitute a safety issue because personnel can become caught, for example, on the fed and moving length of adhesive tape such that the application has to be interrupted. With regard to the possibility of large-scale automation of existing manufacturing processes, the applying of double-sided adhesive tapes in industry has accordingly up to now often still been found to be disadvantageous.

The primary object of the present invention was to overcome or at least reduce the above described disadvantages of the prior art.

In particular, the object of the present invention was to specify an end effector and an application system, building thereon, by means of which the application of double-sided adhesive tapes can be simplified such that it should be possible for the application to be performed more efficiently in terms of time and costs compared with end effectors or application systems known from the prior art. It was a desirable requirement here that the end effector to be specified or the application system to be specified should have an advantageous automatability and good integratability into modern manufacturing lines by easy retrofitting.

In addition, an object of the present invention was to specify an end effector and an application system which should allow precise application of double-sided adhesive tapes even under challenging manufacturing conditions, such as for example in limited space conditions as can occur, for example, when fitting parts to vehicle roof linings. It was a desirable requirement here that the end effector to be specified should make an advantageous contribution to working and process safety, in particular because the end effector should allow reliable application of adhesive tapes even without cutting units.

An object of the present invention was also that the demands placed on the feed arrangement of the end effector to be specified and the application system to be specified should be reduced, wherein in particular the need for external feed devices and roll unwinders should be reduced. In this respect, it was a desirable requirement that the risk of double-sided adhesive tapes getting dirty and sticking in the end effector or application system to be specified should be minimized.

An object of the present invention was also to supply a method for the application of double-sided adhesive tapes with the end effector to be specified or the application system to be specified.

An object of the present invention was moreover that the effort to apply double-sided adhesive tapes should be reduced with the method to be specified by efficient automatability, wherein the method should desirably also have increased process stability and working safety compared with the prior art.

A secondary object of the present invention was to specify use of the end effector to be specified for the application of double-sided adhesive tapes, in particular when fitting parts to vehicle roof linings.

The inventors of the present invention have now found that the above objects can surprisingly be achieved if a roll holder with a guide arrangement for the adhesive tape is integrated into an end effector for the application of double-sided adhesive tapes, if an application arrangement of the end effector is designed such that the adhesive layer of a double-sided adhesive tape held in the roll holder and guided in the guide arrangement can be attached to a substrate to be bonded on the outside of the end effector, provided that a separation layer detached from the double-sided adhesive tape in the application arrangement can be discharged from the end effector by means of a discharge arrangement, as is defined in the claims. The compact structure and the integration of a plurality of components, in particular of the adhesive tape roll holder and the feed arrangement, here allows flexible use of the corresponding end effector in a wide range of manufacturing processes, in particular even in confined space conditions, wherein not only can excellent automatability be achieved but structural space can also be saved and faults in the adhesive tape feed minimized because of shorter adhesive tape feed distances. The resulting end effector can be used particularly advantageously for adhesively bonding components and cable harnesses to the roof lining, wherein in particular coupling and uncoupling the corresponding end effector to and from the automated movement unit is also possible in a particularly simple fashion such that, for example, tape replacement, maintenance and repair can be carried out simply.

The abovementioned objects are thus achieved by the subject-matter of the invention, as defined in the claims. Preferred embodiments according to the invention can be found in the dependent claims and the following explanations.

Such embodiments which are referred to below as preferred are combined in particularly preferred embodiments with features of other embodiments which are referred to as preferred. Combinations of two or more of the embodiments referred to below as particularly preferred are thus very particularly preferred. Also preferred are embodiments in which a feature of an embodiment which is referred to as preferred to any extent is combined with one or more further features of other embodiments which are referred to as preferred to any extent. Features of preferred application systems, methods and uses can be found in the features of preferred end effectors.

The invention relates to an end effector for the application of double-sided adhesive tapes with an automated movement unit, comprising:
a) a roll holder,
b) a guide arrangement,
c) an application arrangement, and
d) a discharge arrangement,
wherein the roll holder is configured to hold an adhesive tape roll,
wherein the guide arrangement is configured to guide an adhesive tape, supplied from an adhesive tape roll arranged in the roll holder, from the roll holder to the application arrangement,
wherein the application arrangement is configured to guide an adhesive tape which is fed to the application arrangement such that the adhesive layer of the adhesive tape is situated in an application area on the outside of the end effector such that the end effector can contact a substrate to be bonded with the adhesive layer of the adhesive tape, and
wherein the discharge arrangement is configured to discharge a separation layer, detached in the application arrangement from the adhesive layer, of an adhesive tape from the end effector. The end effector according to the invention is suitable for the application of double-sided adhesive tapes with an automated movement unit. In accordance with the knowledge of a person skilled in the art, an end effector is the executive and/or terminal element of automated movement units, for example robot arms. In other words, end effectors in the field of robotics are the last component of a kinematic chain. The term “executive element” here means in particular that the end effector is in most cases configured to execute an externally specified execution instruction which can be communicated, for example, to the automated movement unit and/or the end effector via an electronic control device.

According to the invention, the end effector comprises a roll holder which is configured to hold an adhesive tape roll. Adhesive tape rolls in practice generally have an essentially hollow-cylindrical geometrical shape, wherein an adhesive tape can be placed or wound circumferentially around the outer surface of the adhesive tape roll. By repeatedly winding the adhesive tape around the adhesive tape roll, both efficient storage of the adhesive tape and safe use can thus be achieved, for example by the adhesive tape being unrolled from the adhesive tape roll and applied when necessary. Adhesive tape rolls generally have a through recess along their cylinder axis, via which the adhesive tape roll can be placed on a for the most part complementary projection of a roll holder such that rotation remains possible but the adhesive tape roll has reduced translational degrees of freedom in the roll holder. A person skilled in the art knows that the end effector according to the invention is configured by the roll holder to hold and process an adhesive tape roll and consequently a double-sided adhesive tape but that neither the adhesive tape roll nor the double-sided adhesive tape itself are part of the end effector.

According to the invention, the end effector moreover comprises an application arrangement and a guide arrangement for the guidance of an adhesive tape from the roll holder to the application arrangement. The guidance of the adhesive tape can expediently be effected by suitable guide elements such as, for example, rotatably mounted guide rollers. An end effector according to the invention is expedient for essentially all the embodiments, wherein the end effector comprises in the guide arrangement one or more, preferably two or more, preferably four or more, preferably six or more guide elements, preferably guide rollers, for the guidance of the adhesive tape, wherein preferably one or more of the guide elements are driven guide elements, preferably electrically driven guide elements.

In order to reduce the risk of sticking and to ensure reliable application of double-sided adhesive tapes, an adhesive tape guided in the end effector according to the invention is advantageously retained under tension in the guide arrangement, even when the relative changes in distance between the application arrangement and the roll holder are reduced compared with the prior art. The tensile stress of the adhesive tape in the guide arrangement refers, in accordance with the knowledge of a person skilled in the art, to the tensile stress on the adhesive tape inside the guide arrangement. The value of the tensile stress set inside the guide arrangement here in practice usually lies within a predefined range which is usually readily clear to a person skilled in the art from the respective requirements of the use case. For example, the upper limit of this range can result from the tensile strength of the guided adhesive tape. The lower limit of the range can result, for example, from the minimum tensile stress necessary for controlled guidance and/or clean severing of the adhesive tape. The inventors have now recognized that an essentially uniform tension of the adhesive tape in the guide arrangement advantageously allows particularly uniform application of the adhesive tape and additionally ensures safe guidance of the adhesive tape, as a result of which undesired sticking of the adhesive tape in the guide arrangement can be reliably prevented. In this respect, it has proved to be advantageous to provide an element, influencing the tension of the adhesive tape, in the guide arrangement, on the basis of which this tensile stress can be set and controlled in a targeted fashion in order to build up or equalize a tensile stress. Accordingly, an end effector according to the invention is preferred, wherein the end effector comprises a repositionable web-tensioning element, preferably a web-tensioning roller, in the guide arrangement, wherein the web-tensioning element is configured to change its position reversibly and non-destructively relative to further parts of the guide arrangement, preferably relative to guide elements which are adjacent with respect to the guided length of adhesive tape, when the adhesive tape is tensioned in the guide arrangement, preferably when a predefined tensile stress on the web-tensioning element, caused by the tension of the adhesive tape, is exceeded, in order to at least partially equalize the tensile stress. An end effector according to the invention is therefore additionally or alternatively also preferred, wherein the web-tensioning element is configured such that the adhesive tape can be tensioned in the guide arrangement by a reversible and non-destructive change in the position of the web-tensioning element.

The inventors have recognized that the active management of the feeding of the adhesive tape and the controlling of the web tension are very important if particularly effective end effectors are to be obtained. In this context, in the opinion of the inventors it is in the first place expedient not just to rely on passive unrolling of the adhesive tape, which would be possible in a freely rotatable arrangement of the adhesive tape roll in the roll holder after an external tensile force has been applied, and instead rather to provide an active drive for the adhesive tape roll which supplies adhesive tape from the adhesive tape roll actively and in controllable conditions. An end effector according to the invention is therefore in the first place preferred, wherein the end effector comprises a drive unit for driving the adhesive tape roll in the roll holder, preferably a motor, particularly preferably an electric motor.

Additionally or alternatively, the inventors consider it particularly advantageous if active control of the drive unit and/or the web-tensioning element responsible for setting the web tension is provided or enabled, which can be enabled by an electronic control unit.

With regard to optimal guidance of the adhesive tape, an end effector according to the invention is thus preferred, wherein the end effector comprises an electronic control unit which is configured to control the drive unit and/or the position of the web-tensioning element, wherein configuration of the electronic control unit to control both components is preferred. The electronic control unit can be arranged, for example, so as to be part of the automated movement unit which is connected to the end effector according to the invention. In this embodiment, the electronic control unit preferably controls not only the above components of the end effector but also the end effector itself or the automated movement unit.

An electronic control unit which controls both the drive unit and the position of the web-tensioning element is here particularly preferred with regard to as constant as possible a tensile stress on an adhesive tape guided in the end effector such that, for example, sticking of the adhesive tape can be reliably avoided. In the opinion of the inventors, it has proven to be very particularly advantageous if the web-tensioning roller serves here even as an input for the control loop of the unwinding. By virtue of such dependent controlling of both components, i.e. motorized unwinding assistance, optimal and safe guidance of the adhesive tape and precise control of the application amount are ensured. Accordingly, an end effector according to the invention is particularly preferred, wherein the electronic control unit is configured to control the drive unit depending on the position of the web-tensioning element.

According to the invention, the end effector comprises an application arrangement, this being the term used for the part of the end effector which is responsible for the actual application of the adhesive tape to a substrate which is to be bonded, wherein the subarea of the application arrangement in which the transfer of the adhesive tape to the substrate and the detachment of the liner take place is referred to within the scope of the present invention as the application area. The application area is thus the area of the application arrangement in which the adhesive tape is applied to a substrate. In practice, this usually means that the adhesive layer of the adhesive tape is pressed onto a substrate in the application area in order to apply the adhesive tape to the substrate. According to the invention, for this purpose the adhesive layer of the adhesive tape is situated on the outside of the end effector in the application area of the application arrangement. In this respect, in most cases the application area is essentially freely accessible from outside the end effector. Accordingly, the application area is arranged at least in part on the outside of the end effector. The outside here refers in particular to the part of the application arrangement which is remote from the further components of the end effector. Within the scope of the invention, the structure which contacts the adhesive tape from underneath at the time of the application is referred to as the application element. Against this background, an end effector according to the invention is relevant for essentially all the embodiments, wherein the application arrangement comprises an application element, preferably an application roller, wherein the application element is configured such that the adhesive tape is guided in the application area over the surface of the application element and/or around the application element, preferably over the surface of the application element and around the application element, such that the adhesive layer faces away from the application element.

The end effector according to the invention is advantageously not limited in terms of the further configuration of the application arrangement. An example is an end effector according to the invention, wherein the application arrangement comprises one or more, preferably two or more, particularly preferably precisely two, auxiliary guide elements, preferably auxiliary guide rollers, which are configured to guide the adhesive tape in the application arrangement over the surface of the application element and/or around the application element.

The components of the end effector according to the invention are combined in the end effector and for this purpose expediently connected to each other, for example in a housing. Accordingly, an end effector according to the invention is relevant for essentially all the embodiments, wherein the end effector comprises a support structure, preferably a support plate, on which the further constituent parts of the end effector are arranged and/or to which the further constituent parts of the end effector are connected.

With regard to safe and efficient application of adhesive tapes, it has proved to be advantageous to provide the application arrangement as a whole, preferably at least the application element of the application arrangement, as spring-mounted on the end effector according to the invention. As a result, the contact pressure on the substrate to be bonded can be better controlled or be reduced during the application of an adhesive tape guided in the application arrangement such that in particular damage to the substrate can be avoided. In this respect, an end effector according to the invention is preferred, wherein the application arrangement is connected via a spring arrangement to the further constituent parts of the end effector, preferably to the support structure of the end effector.

According to the invention, the end effector comprises in addition a discharge arrangement which diverts a separation layer, detached from the adhesive layer of the adhesive tape in the application arrangement, away from the end effector. This separation layer, also referred to as a liner, functions as a backing until the adhesive tape is applied and then has to disposed of as waste or fed to a recycling system. In this respect, the inventors have succeeded in identifying embodiments of the discharge arrangement by means of which particularly efficient end effectors could be obtained and which in particular ensure reliable diverting of the separation layer.

For this purpose, in the first place, for example, driven or freely rotatable rollers can be provided which either just stabilize the discharged separation layer or, by means of the drive, also at the same time promote or effect extraction from the application area. Accordingly, an end effector according to the invention is preferred, wherein the discharge arrangement comprises one or more discharge elements, preferably discharge rollers, wherein the discharge arrangement preferably comprises at least one roller arrangement with at least two rollers rotating in opposite directions and which is configured such that the separation layer detached from the adhesive layer can be guided through between the rollers rotating in opposite directions, wherein the rollers of the roller arrangement are preferably rollers driven in opposite directions and the discharge arrangement is configured to discharge the separation layer from the application area as a consequence of the movement of the rollers driven in opposite directions.

It is in principle possible to divert the discharged separation layer then via a rewinding device, for example an external mechanical rewinding device. The diverting of the separation layer is, however, advantageously promoted or effected by a suction unit, as a result of which complicated separate threading of the separation layer into the outlet hole can be avoided. In this preferred embodiment, the separation layer can accordingly be diverted particularly efficiently. In this respect, an end effector according to the invention is preferred, wherein the discharge arrangement comprises an outlet hole for the discharge of the separation layer, wherein the outlet hole is preferably connected to a fluid line system and/or wherein the discharge of the separation layer is promoted or effected by the outlet hole, preferably by a suction unit.

In practice, it has proven to be advantageous if a largely fully automated application of the adhesive tape is enabled by the end effector according to the invention. This relates in particular also to the completion of an application procedure and/or interrupting an application procedure by ending the feeding of the adhesive tape and severing the adhesive tape. In this respect, the inventors have recognized that it is advantageous to provide a braking device in the end effector in order to automatedly slow down, preferably brake, an adhesive tape guided in the end effector or an adhesive tape applied by means of the end effector such that further displacement of the end effector following the prevention of additional delivery of adhesive tape causes the adhesive tape to be torn. In order to make this possible, the adhesive layer of the adhesive tape used should have a sufficiently low elongation at break, wherein corresponding adhesive tapes are commercially available, for example under the name tesa 50400. In this embodiment, the braking unit correspondingly enables tearing of the adhesive tape such that, after a predetermined amount of adhesive tape has been output, advantageously no separate separating devices for severing the adhesive tape have to be provided at the end effector and the applied adhesive tape does not have to be severed manually. The separation layer with usually a significantly higher tensile strength is advantageously not severed such that rethreading of the separation layer into the discharge arrangement in the end effector according to the invention can be avoided. In addition, in this embodiment, there is advantageously no need for a separate pre-winding unit for pre-winding the adhesive tape for a subsequent application cycle, in particular if the end effector is designed such that the adhesive tape tears directly in the application arrangement or in the application area, preferably at the application element. An end effector according to the invention is thus preferred, wherein the end effector comprises a braking unit, preferably a pneumatic brake, wherein the braking unit is configured to make the feeding of the adhesive tape into the application arrangement and/or the guidance of the adhesive tape in the application arrangement harder or to prevent it, preferably to prevent it. In this respect, the inventors have succeeded in identifying embodiments of the braking unit which in practice particularly reliably make the guidance of the adhesive tape harder or prevent it and which, after engaging with it, advantageously also favour reliable tearing of an easily tearable adhesive tape when the end effector is displaced. Namely, an end effector according to the invention is preferred, wherein the braking unit is configured to make the feeding of the adhesive tape into the application arrangement and/or the guidance of the adhesive tape in the application arrangement harder, or to prevent it, by application of a contact pressure to the adhesive tape guided in the guide arrangement and/or application arrangement, preferably to the adhesive tape guided in the guide arrangement. It is known to a person skilled in the art that the term contact pressure in this context refers to the pressure exerted by the braking unit on the adhesive tape, which is applied for example by the braking unit, by the adhesive tape being pressed against a component of the application arrangement or the guide arrangement. Alternatively, an end effector according to the invention is preferred, wherein the braking unit is configured to make the make the feeding of the adhesive tape into the application arrangement and/or the guidance of the adhesive tape in the application arrangement harder, or to prevent it, by locking guide elements of the guide arrangement and/or by locking the rotation of the adhesive tape roll arranged in the roll holder, preferably by locking guide elements of the guide arrangement.

As explained above, the end effector according to the invention can, when a braking unit is used, advantageously achieve severing of an adhesive tape guided in the end effector without any separating devices such that, in addition to a reduction in the complexity of the equipment, in particular the working safety of the end effector according to the invention is also improved compared with known end effectors. It may nevertheless be expedient in certain cases to provide separating devices, for example because the adhesive tape to be applied does not have the necessary tensile strength, wherein the end effector in this case usually probably comprises at least one pre-winding device for repositioning the adhesive tape in the guide arrangement and/or the application arrangement after the adhesive tape has been severed. An end effector according to the invention is accordingly theoretically conceivable, wherein the end effector comprises one or more separating devices, preferably cutting blades, which are configured to sever the adhesive layer and/or the adhesive tape, preferably the adhesive layer, wherein the separating devices are preferably arranged in the region of the application arrangement, particularly preferably immediately upstream of the application area with respect to the guided length of adhesive tape.

In the opinion of the inventors, an end effector according to the invention which is optimized by the braking unit for the application of easily tearable adhesive tapes, i.e. adhesive tapes with an adhesive layer which has a tensile strength of 10 N/cm² or less and/or an elongation at break of 50% or less is particularly advantageous. Accordingly, preferred for all the embodiments is an end effector according to the invention for the application of easily tearable double-sided adhesive tapes, the adhesive layer of which has a tensile strength of 10 N/cm² or less and/or an elongation at break of 50% or less, with an automated movement unit, comprising:
a) a roll holder,
b) a guide arrangement,
c) an application arrangement, and
d) a discharge arrangement,
wherein the roll holder is configured to hold an adhesive tape roll,
wherein the guide arrangement is configured to guide an adhesive tape, supplied from an adhesive tape roll arranged in the roll holder, from the roll holder to the application arrangement,
wherein the application arrangement is configured to guide an adhesive tape which is fed to the application arrangement such that the adhesive layer of the adhesive tape is situated in an application area on the outside of the end effector such that the end effector can contact a substrate to be bonded with the adhesive layer of the adhesive tape, and
wherein the discharge arrangement is configured to discharge a separation layer, detached in the application arrangement from the adhesive layer, of an adhesive tape from the end effector,
wherein the end effector comprises a braking unit, wherein the braking unit is configured to make the feeding of the adhesive tape into the application arrangement and/or the guidance of the adhesive tape in the application arrangement harder or to prevent it, wherein the end effector preferably does not comprise separate separating devices for severing the adhesive tape.

Against this background, an end effector system comprising an end effector according to the invention with a braking unit is also disclosed, wherein arranged in the roll holder of the end effector according to the invention is an adhesive tape roll with an adhesive tape, the adhesive layer of which has a tensile strength of 10 N/cm² or less, preferably 9 N/cm² or less, particularly preferably 8.5 N/cm² or less, and/or an elongation at break of 50% or less, preferably 40% or less, particularly preferably 35% or less.

The end effector according to the invention can, with regard to an as fault-free an application as possible of adhesive tapes, advantageously comprise a first electronic detection unit which detects, for example, the condition of the adhesive layer of the adhesive tape in order to register and prevent, for example, the application of a faulty adhesive tape. The condition of the adhesive layer here refers, for example, to the visual appearance of the adhesive layer, in particular to the detection of dirt and/or damage on the adhesive layer. The first electronic detection unit can here alternatively or additionally be configured to detect the complete absence of the adhesive layer. The detection takes place in most cases using an optical method. An end effector according to the invention is preferred here, wherein the first electronic detection unit comprises an optical sensor, preferably a camera or a colour sensor, particularly preferably a colour sensor.

For this purpose, the adhesive tapes and/or separating liners are designed, for example, as coloured. For example, the adhesive layer and the separation layer can have different colours such that it can be registered if the separation layer is exposed. Alternatively, the adhesive layer can, for example, be designed as coloured but the separation layer as essentially transparent such that, in the event that the separation layer is exposed, only the respective detection background of the first electronic detection unit is detected. Accordingly, an end effector according to the invention is preferred, wherein the end effector comprises a first electronic detection unit, wherein the first electronic detection unit is configured to detect the presence of the adhesive layer in the adhesive tape and/or the condition of the adhesive layer in the adhesive tape before the adhesive tape has passed through the application area of the application arrangement.

The inventors have identified embodiments for the first electronic detection unit which are particularly preferred in terms of the arrangement in the end effector and by means of which in practice particularly reliable quality checks could be performed and which thus ensure particularly reliable and fault-free application. Namely, an end effector according to the invention is preferred, wherein the first electronic detection unit is arranged in the region of the application arrangement, preferably immediately upstream of the application area with respect to the guided length of adhesive tape.

The quality check by the first electronic detection unit upstream of the application of the adhesive tape can additionally be used to control the end effector such that disruption owing to a faulty adhesive layer can be avoided, for example by ending the application and/or interrupting the application following a corresponding output signal of the first electronic detection unit. With regard to avoiding faulty adhesive tape application procedures, to avoiding excessive rejects and to achieving a high degree of automation, the inventors correspondingly propose that the information detected by the first electronic detection unit should advantageously serve to control the further components of the end effector. An end effector according to the invention is therefore preferred, wherein the end effector comprises an electronic control unit which is configured to control the end effector, preferably the braking unit and/or the drive unit, depending on the information detected by the first electronic detection unit. An end effector according to the invention is also preferred, wherein the electronic control unit is configured to prevent the feeding of the adhesive tape into the application arrangement and/or the guidance of the adhesive tape in the application arrangement and/or the applying of the adhesive tape when the first electronic detection unit detects the absence of the adhesive layer in the adhesive tape and/or an inadequate condition of the adhesive layer, preferably a condition of the adhesive layer which is outside a tolerance range, in the adhesive tape.

Checking that the adhesive tape has been successfully applied in the end effector according to the invention can advantageously be performed by a second electronic detection unit which detects the absence of the adhesive layer after the application has been made. The detection here also in this case takes place in most cases optically. An end effector according to the invention is likewise preferred here, wherein the second electronic detection unit comprises an optical sensor, preferably a camera or a colour sensor, particularly preferably a colour sensor.

The quality check by the second electronic detection unit after the adhesive tape has been applied can thus, in a similar fashion to the first electronic detection unit, prevent disruption owing to faulty application, for example by ending the application or outputting a warning signal, when an inadequate application is detected which is manifested on the adhesive layer in the remainder of the adhesive tape. Accordingly, an end effector according to the invention is preferred, wherein the end effector comprises a second electronic detection unit, wherein the second electronic detection unit is configured to detect the absence of the adhesive layer after the adhesive tape has passed through the application area of the application arrangement.

The inventors have also identified a particularly suitable positioning for the second electronic detection unit by means of which in practice particularly reliable final checks could be performed by virtue of the immediacy of the evaluation and which thus ensure particularly safe application. Namely, an end effector according to the invention is preferred, wherein the second electronic detection unit is arranged in the region of the application arrangement, preferably immediately downstream of the application area relative to the guided length of adhesive tape.

It is also preferred for the second detection unit if the output is used to control the end effector or its components. Consequently, an end effector according to the invention is preferred, wherein the end effector comprises an electronic control unit which is configured to control the end effector, preferably the braking unit and/or the drive unit, depending on information detected by the second electronic detection unit. An end effector according to the invention is also preferred, wherein the electronic control unit is configured to prevent the feeding of the adhesive tape into the application arrangement and/or the guidance of the adhesive tape in the application arrangement and/or the applying of the adhesive tape if the second electronic detection unit detects the presence of the adhesive layer in the adhesive tape.

The inventors consider it to be particularly expedient with regard to the high quality requirements of modern automated manufacturing processes if an optical check is made both upstream and downstream of the application area. Accordingly, an end effector according to the invention is very particularly preferred, wherein the end effector comprises the first electronic detection unit and the second electronic detection unit, wherein the first electronic detection unit and the second electronic detection unit preferably comprise the same sensors, particularly preferably the same optical sensors.

The inventors have lastly also succeeded in identifying fundamental embodiments of the end effector by means of which in practice particularly reliable application of adhesive tapes, in particular even under challenging manufacturing conditions, could be achieved and which are in the opinion of the inventors advantageously suitable for integration into existing manufacturing lines. Namely, an end effector according to the invention is preferred, wherein the end effector has a mass in the range from 10 to 50 kg, preferably in the range from 12 to 40 kg, particularly preferably in the range from 14 to 30 kg. The end effector according to the invention is particularly well suited to large-scale automation. A person skilled in the art sometimes also speaks of the end effector according to the invention being integratable extremely well into industry 4.0 projects. A replaceable end effector according to the invention is relevant for this in most cases, wherein the end effector comprises a connection element for connecting the end effector to an automated movement unit, wherein the connection element is preferably arranged on the support structure of the end effector. An example here is an end effector according to the invention, wherein the connection element is arranged on the side of the end effector remote from the application area.

The invention also relates to an application system for the application of double-sided adhesive tapes, comprising:
x) an automated movement unit, and
y) an end effector according to the invention which is connected to the automated movement unit.

The application system according to the invention comprises an automated movement unit and an end effector according to the invention which is connected to the automated movement unit. A person skilled in the art knows that the preferred application system according to the invention correspondingly also has the advantages of preferred end effectors. In practice, the end effector according to the invention is usually connected to the automated movement unit as a terminal element such that the end effector according to the invention enables the application of double-sided adhesive tapes as an executive element.

An application system according to the invention is preferred with regard to precise controllability and a high degree of automation, wherein the automated movement unit is a linear axis system or a robot arm, preferably a robot arm.

The application system according to the invention is advantageously suited for large-scale automation of application methods, for which purpose it expediently comprises an electronic data processing device for control purposes. An application system according to the invention is therefore relevant in most cases, wherein the application system comprises an electronic data processing device for controlling the end effector and the automated movement unit, preferably depending on bonding instructions stored in a memory of the electronic data processing device. Bonding instructions are the control commands and instructions which can be read, for example, by control software. These control commands can comprise, for example, specifications of the length of the adhesive tape to be applied and/or movement rules for the automated movement unit.

The invention moreover relates to a method for the application of double-sided adhesive tapes with an end effector according to the invention or an application system according to the invention, comprising the method steps:
i) producing or supplying an adhesive tape roll with an adhesive tape in the roll holder, wherein the adhesive tape comprises at least one adhesive layer arranged on a separation layer,
ii) feeding the adhesive tape from the adhesive tape roll arranged in the roll holder to the application arrangement with the guide arrangement,
iii) guiding the adhesive tape in the application arrangement, wherein the adhesive layer of the adhesive tape is situated on the outside of the end effector in the application area,
iv) contacting a substrate to be bonded with the adhesive layer of the adhesive tape by means of the end effector in the application area and detaching the adhesive layer of the adhesive tape from the separation layer in order to apply the adhesive layer to the substrate,
v) discharging the separation layer detached from the adhesive layer of the adhesive tape with the discharge arrangement.

The method according to the invention serves for the application of double-sided adhesive tapes with an end effector according to the invention or an application system according to the invention. The method according to the invention comprises for this purpose producing or supplying an adhesive tape roll with an adhesive tape in the roll holder of the end effector. The inventors have identified with respect to the adhesive tape roll particularly suitable embodiments by means of which particularly efficient procedures could be achieved in practice. Namely, a method according to the invention is preferred, wherein the adhesive tape roll has a mass within the range from 5 to 15 kg, preferably within the range from 5 to 8 kg.

A method according to the invention is expedient for essentially all the embodiments, wherein the adhesive tape roll is supplied in method step i) from a storage system and inserted into the roll holder. An example is a method according to the invention, wherein the adhesive tape roll is supplied in method step i) by replacing an empty adhesive tape roll.

The term adhesive tape is clear for a person skilled in the art of bonding technology. Within the scope of the present invention, the word tape refers to all thin flat objects, i.e. objects which extend predominantly in two dimensions, in particular films, sections of film and labels, preferably tapes with an extensive length and a limited width as well as corresponding sections of tape. The adhesive tape arranged on the adhesive tape roll is here a double-sided adhesive tape such that it comprises, for example, two adhesive layers which are arranged on different sides of a backing, wherein backingless adhesive tapes are also conceivable.

According to the invention, the adhesive tape comprises at least one adhesive layer arranged on a separation layer, wherein, in light of the above explanation, further plies can be provided between the separation layer and the top adhesive ply, in particular a possible backing in addition to a second backing of a backing-based double-sided adhesive tape. In other words, a method according to the invention is also relevant in most cases, wherein the adhesive layer consists of an adhesive ply made from an adhesive substance, or wherein the adhesive layer consists of an adhesive ply made from a first adhesive substance and a backing ply, and optionally further adhesive plies made from further adhesive substances.

Customary materials can be used as separation layers which are usually referred to as liners. An example is a method according to the invention, wherein the separation layer comprises one or more materials which are selected from the group consisting of polyethylene, polypropylene, polyethylene terephthalate, paper and combinations of these materials, wherein the separating material is coated preferably on one or both sides, particularly preferably on both sides, with a release layer, preferably a silicone release layer, wherein the silicone release layer can be produced very particularly preferably by crosslinking a crosslinkable silicone system comprising one or more polysiloxanes. Corresponding separation layers thus allow in particular problem-free unwinding of the adhesive tape from the adhesive tape roll and protect the rear of the adhesive layer from dirt. When separation layers release-coated on both sides are used in conjunction with a braking unit in the end effector according to the invention, it is in this respect preferred for a good braking effect to design the braking unit in the contact area with a rubber coating and/or with a macroscopic surface structure, for example in the form of needle points, in order to reduce the risk of undesired slipping of the adhesive tape after engagement of the braking unit.

In terms of the handling properties of the adhesive tapes, a method according to the invention is particularly preferred, wherein the adhesive layer is a pressure-sensitive adhesive layer. A pressure-sensitive adhesive layer is, in accordance with the understanding of a person skilled in the art, an adhesive layer which has pressure-sensitive adhesive properties, i.e. the property of assuming a permanent connection to a primer under relatively weak contact pressure. Corresponding pressure-sensitive adhesive tapes can usually be detached again from the primer after use, leaving essentially no residues, and are generally permanently tacky already at room temperature, which means that they have a certain viscosity and tackiness such that they wet out the surface of a substrate with just a small amount of contact pressure.

With regard to the process stability and an efficient procedure of the method according to the invention, the inventors have identified particularly suitable parameters for the adhesive tape. As already explained above with reference to the end effector according to the invention, the use of adhesive tapes with a low elongation at break is explicitly preferred because severing of such adhesive tapes can usually be effected without any mechanical separating devices when a braking unit is used. Because such adhesive tapes tear easily, they can be safely severed, even without manual or automated separating devices, essentially by sudden braking. In this respect, in particular a method according to the invention is preferred, wherein the adhesive layer has a tensile strength of 10 N/cm² or less, preferably 9 N/cm² or less, particularly preferably 8.5 N/cm² or less. Alternatively or additionally, a method according to the invention is preferred, wherein the adhesive layer has an elongation at break of 50% or less, preferably 40% or less, particularly preferably 35% or less. Tensile strength refers to the maximum mechanical tensile stress that can be applied to a body without tearing the latter. In contrast, elongation at break refers to the percentage change in length of a body after tearing relative to its initial length.

According to the invention, the method according to the invention moreover comprises the guidance of the adhesive tape from the adhesive tape roll via the guide arrangement to the application arrangement. According to the invention, the adhesive layer of the adhesive tape is thus situated on the outside of the end effector in the application area such that a substrate to be bonded can be contacted with the adhesive layer of the adhesive tape. A method according to the invention is expedient here in most cases, wherein contacting of the substrate to be bonded with the adhesive layer of the adhesive tape takes place by means of a movement of the end effector, wherein the movement of the end effector is preferably effected by the automated movement unit.

According to the invention, the method according to the invention additionally comprises detaching the adhesive layer of the adhesive tape from the separation layer, which is effected essentially by the stronger adhesion of the adhesive layer to the substrate and is possibly promoted by the shape of the application element, and then the discharging of the separation layer by means of the discharge arrangement. It can be viewed here as an advantage of the method according to the invention that it is not limited in terms of possible further method steps.

In practice, in this respect a method according to the invention is probably relevant for essentially all the embodiments, additionally comprising the method step:
vi) moving the end effector contacting the substrate over the surface of the substrate.

Moving the end effector preferably enables a predetermined amount of adhesive tape to be applied along a predetermined stretch of the substrate surface.

The method according to the invention is suitable for bonding various substrates and is accordingly fundamentally not limited in this respect. However, in principle a method according to the invention is relevant in most cases, wherein the substrate is a part on which further components are to be fastened by means of the adhesive layer. An example is a method according to the invention, wherein the substrate comprises a vehicle part, wherein the substrate preferably comprises a roof lining. In the case of vehicles, a roof lining refers to the inner covering of the vehicle roof.

A method according to the invention is also preferred, in particular when a braking unit is provided in the end effector, additionally comprising the method step:
vii) lifting the end effector from the substrate after a predetermined amount of the adhesive layer has been applied and the adhesive layer has been severed between the end effector and the substrate.

As explained above, the severing is preferably effected in the method step vii) by the braking unit of the end effector, wherein activating the braking unit prevents the guidance of the adhesive tape in the application arrangement such that an adhesive tape with an adhesive layer of low elongation at break tears in the application arrangement, particularly preferably directly at the application element. The separation layer here generally remains unsevered. In a correspondingly preferred embodiment, a particularly high degree of working safety can be achieved in the method according to the invention, in particular by the omission of separate separating devices for the adhesive tape. A method according to the invention is therefore explicitly preferred, wherein the severing of the adhesive layer is effected or promoted by the braking unit of the end effector which makes the feeding of the adhesive tape into the application arrangement and/or the guidance of the adhesive tape in the application arrangement harder or prevents it. In this respect, a method according to the invention is preferred, wherein the severing of the adhesive layer is effected or promoted by the end effector being lifted from the substrate at an angle in the range from 15 to 50°, preferably in the range from 20 to 40°, particularly preferably in the range from 25 to 35°.

The method according to the invention is, however, advantageously not limited in terms of the severing. Accordingly, a method according to the invention is also at least theoretically conceivable, wherein severing the adhesive layer is effected or promoted by the separating device of the end effector.

A method according to the invention is now also preferred, additionally comprising the method step:
viii) pressing one or more components onto the adhesive layer applied to the substrate in order to obtain an adhesive bond, wherein the pressing is preferably effected in an automated method by an automated device.

A method according to the invention is, for example, conceivable here, wherein the substrate is a roof lining and wherein at least one vehicle moulded part and at least one cable harness can be pressed as components onto the adhesive layer applied to the substrate.

With regard to a time-and cost-efficient procedure, in particular in the automotive industry, a method according to the invention is preferred, wherein in the method one or more moulded parts are adhesively bonded to a roof lining by means of the applied adhesive tape and/or wherein in the method one or more cable harnesses are adhesively bonded to a roof lining by means of the applied adhesive tape.

For the purpose of an increased degree of efficiency, it is here in particular also possible to simultaneously process a plurality of originally separate work steps in a single work step by means of the method according to the invention. A method according to the invention is therefore also preferred, wherein in the method one or more moulded parts and one or more cable harnesses are adhesively bonded, wherein the adhesive bonding takes place at the same work station of a manufacturing line and/or by means of the same end effector.

In addition, also disclosed is the use of an end effector according to the invention for the application of double-sided adhesive tapes with an automated movement unit in automotive manufacturing for fastening cable harnesses and moulded parts, preferably to a roof lining, in order to increase the manufacturing efficiency.

Preferred embodiments of the invention are explained and described in detail below with reference to the attached Figures, in which:

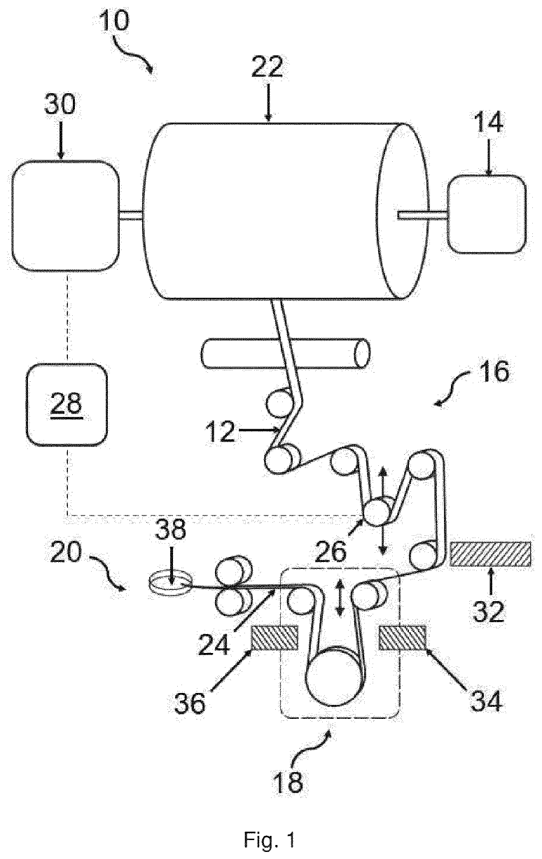

FIG. 1 shows a schematic illustration of an end effector according to the invention in a preferred embodiment.

FIG. 1 shows a schematic illustration of an end effector 10 according to the invention for the application of double-sided adhesive tapes 12 in a preferred embodiment.

The end effector 10 comprises a roll holder 14 which can be driven via a drive unit 30 and on which in the example shown an adhesive tape roll 22 with a typical double-sided adhesive tape 12 is arranged, wherein the double-sided adhesive tape 12 comprises a backing ply and two tacky adhesive plies. This adhesive layer is arranged on a separation layer 24 which is coated on both sides with a release layer. The adhesive layer of the illustrated adhesive tape 12 has a tensile strength of no more than 10 N/cm² or an elongation at break of no more than 50%, wherein the double-sided adhesive tape 12 can be, for example, the product tesa 50400.

In the end effector 10 shown, the double-sided adhesive tape 12 is guided via a guide arrangement 16 from the roll holder 14 or the adhesive tape roll 22 arranged therein to an application arrangement 18 of the end effector 10, said application arrangement being indicated by a box in dashed lines. For this purpose, the guide arrangement 16 comprises six guide rollers in the example shown, some of which can be driven electrically. One of these guide rollers is designed as a repositionable web-tensioning element 26, wherein the reversible and non-destructive change in position of the web-tensioning element 26 is illustrated in FIG. 1 relative to the further guide rollers by direction arrows.

In use, in a method according to the invention, the tensile stress of the adhesive tape 12 in the guide arrangement 16 is set via the web-tensioning element 26 by movement of the web-tensioning element 26 in the direction of the direction arrows such that a predefined tensile stress, caused by the tension of the adhesive tape 12, on the web-tensioning element 26 is not exceeded. The control of the web-tensioning element 26 takes place here by means of an electronic control unit 28 which also controls the drive unit 30 depending on the position of the web-tensioning element 26.

In the end effector 10 shown, the adhesive tape 12 introduced into the application arrangement 18 is guided over the surface of an application element of the application arrangement 18 and around this application element via an auxiliary guide roller such that the adhesive layer faces away from the application element in an application area at the lower end of the illustrated end effector 10 such that the end effector 10 can contact a substrate to be bonded with the adhesive layer. The application arrangement 18 is here connected, spring-mounted, to the end effector 10 or its support plate such that, when the adhesive tape 12 is pressed down, a compensating movement can be made in the direction of the direction arrows illustrated in FIG. 1.

At the application element or in the application area of the application arrangement 18, the separation layer 24 of the adhesive tape 12 is guided via a second auxiliary guide roller to a discharge arrangement 20 of the end effector 10. In the discharge arrangement 20, the separation layer 24 is discharged between two rollers rotating in opposite directions to an outlet hole 38 which is connected to a suction unit (not shown) such that the separation layer 24 can be sucked out of the end effector 10.

The end effector 10 shown moreover comprises a pneumatic braking unit 32 which can prevent the guidance of the adhesive tape 12 in the application arrangement 18 by exerting downward pressure on the adhesive tape 12 guided in the guide arrangement 16. In the end effector 10 shown, activating the braking unit 32 when the end effector 10 is displaced or lifted further causes tearing of the adhesive layer of the adhesive tape 12 in the application area or at the application element. The separation layer 24 remains undamaged in the guidance provided such that the adhesive tape 12 does not have to be rethreaded in the next application cycle or such that there is no need to provide additional pre-winding devices at the end effector 10.

The end effector 10 shown moreover comprises a first electronic detection unit 34, arranged immediately upstream of the application area, with a colour sensor, and a second electronic detection unit 36, arranged immediately downstream of the application area, with a colour sensor. In order to evaluate the success of an application process, the first electronic detection unit 34 can detect the presence and the condition of the adhesive layer in the adhesive tape 12, and the second electronic detection unit 36 can detect the desired absence of the adhesive layer which indicates that it has been successfully transferred to the substrate.

In use, in a method according to the invention, a further electronic control unit, which is also part of the robot control system, controls the braking unit 3 2 (electrically to pneumatically) with separate valve actuation. This further electronic control unit is here also configured to control the braking unit 32 in an emergency depending on the information detected by the first electronic detection unit 34 and the second electronic detection unit 36 such that application of the adhesive tape is prevented if the first electronic detection unit 34 detects the absence of the adhesive layer in the adhesive tape 12 or an inadequate condition of the adhesive layer in the adhesive tape 12, or if the second electronic detection unit 36 detects the presence of the adhesive layer, i.e. unsuccessful application of the adhesive tape 12.

### List of Reference Signs

10 end effector
12 adhesive tape
14 roll holder
16 guide arrangement
18 application arrangement
20 discharge arrangement
22 adhesive tape roll
24 separation layer
26 web-tensioning element
28 electronic control unit
30 drive unit
32 braking unit
34 first electronic detection unit
36 second electronic detection unit
38 outlet hole

1. An end effector for an application of double-sided adhesive tapes with an automated movement unit, the end effector comprising:
a) a roll holder;
b) a guide arrangement;
c) an application arrangement; and
d) a discharge arrangement
wherein
the roll holder is configured to hold an adhesive tape roll,
the guide arrangement is configured to guide an adhesive tape, supplied from an adhesive tape roll arranged in the roll holder, from the roll holder to the application arrangement,
the application arrangement is configured to guide an adhesive tape which is fed to the application arrangement such that the adhesive layer of the adhesive tape is situated in an application area on an outside of the end effector such that the end effector is contactable with a substrate to be bonded with the adhesive layer of the adhesive tape, and
the discharge arrangement is configured to discharge a separation layer, detached in the application arrangement from the adhesive layer, of an adhesive tape from the end effector.

2. The end effector of claim 1, wherein the end effector comprises a repositionable web-tensioning element in the guide arrangement, wherein the web-tensioning element is configured to change its position reversibly and non-destructively relative to further parts of the guide arrangement when the adhesive tape is tensioned in the guide arrangement to at least partially equalize the tensile stress.

3. The end effector of claim 2, wherein the end effector comprises an electronic control unit which is configured to control a drive unit, arranged in the roll holder, for driving the adhesive tape roll and/or a position of the web-tensioning element, wherein the electronic control unit is configured to control the drive unit depending on the position of the web-tensioning element.

4. The end effector of claim 1, wherein the end effector further comprises a braking unit, wherein the braking unit is configured to make a feeding of the adhesive tape into the application arrangement and/or a guidance of the adhesive tape in the application arrangement harder or to prevent it.

5. The end effector of claim 1, wherein the end effector further comprises a first electronic detection unit, wherein the first electronic detection unit is configured to detect a presence of the adhesive layer in the adhesive tape and/or a condition of the adhesive layer in the adhesive tape before the adhesive tape has passed through the application area of the application arrangement.

6. The end effector of claim 5, wherein the end effector further comprises a second electronic detection unit that is configured to detect an absence of the adhesive layer after the adhesive tape has passed through the application area of the application arrangement.

7. The end effector of claim 1, wherein the application arrangement is connected to the further parts of the end effector, via a spring arrangement.

8. The end effector of claim 1, wherein the discharge arrangement comprises an outlet hole for the discharge of the separation layer, wherein the outlet hole is connected to a fluid line system and/or wherein the discharge of the separation layer is promoted or effected by the outlet hole, by a suction unit.

9. An application system for an application of double-sided adhesive tapes, the application system comprising:
x) an automated movement unit, and y) the end effector according to claim 1 that is connected to the automated movement unit.

10. A method for an application of double-sided adhesive tapes with the end effector according to claim 1 , the method comprising:
i) producing or supplying an adhesive tape roll with an adhesive tape in the roll holder, wherein the adhesive tape comprises at least one adhesive layer arranged on a separation layer;
ii) feeding the adhesive tape from the adhesive tape roll arranged in the roll holder to the application arrangement with the guide arrangement;
iii) guiding the adhesive tape in the application arrangement, wherein the adhesive layer of the adhesive tape is situated on the outside of the end effector in the application area;
iv) contacting a substrate to be bonded with the adhesive layer of the adhesive tape by means of the end effector in the application area and detaching the adhesive layer of the adhesive tape from the separation layer for applying the adhesive layer to the substrate; and
v) discharging the separation layer detached from the adhesive layer of the adhesive tape with the discharge arrangement.

11. The method of claim 10, wherein the adhesive layer has a tensile strength of 10 N/cm² or less and/or the adhesive layer has an elongation at break of 50% or less.

12. The method of claim 10, further comprising:
vi) lifting the end effector from the substrate after a predetermined amount of the adhesive layer has been applied and the adhesive layer has been severed between the end effector and the substrate.

13. The method of claim 12, wherein the severing of the adhesive layer is effected or promoted by the braking unit of the end effector which makes a feeding of the adhesive tape into the application arrangement and/or a guidance of the adhesive tape in the application arrangement harder or prevents it.

14. The method of claim 10, further comprising:
vii) pressing one or more components onto the adhesive layer applied to the substrate for obtaining an adhesive bond devices.

15. The method of claim 10, further comprising:
adhesively bonding one or more moulded parts and/or one or more cable harnesses to a roof lining by means of the applied adhesive tape.

16. A method for an application of double-sided adhesive tapes with the application system according to claim 9, comprising the method steps:
i) producing or supplying an adhesive tape roll with an adhesive tape in the roll holder, wherein the adhesive tape comprises at least one adhesive layer arranged on a separation layer;
ii) feeding the adhesive tape from the adhesive tape roll arranged in the roll holder to the application arrangement with the guide arrangement;
iii) guiding the adhesive tape in the application arrangement, wherein the adhesive layer of the adhesive tape is situated on the outside of the end effector in the application area;
iv) contacting a substrate to be bonded with the adhesive layer of the adhesive tape by means of the end effector in the application area and detaching the adhesive layer of the adhesive tape from the separation layer in order to apply the adhesive layer to the substrate; and
v) discharging the separation layer detached from the adhesive layer of the adhesive tape with the discharge arrangement.
